(19) United States
(12) Patent Application Publication
(10) Pub. No.: US 2011/0054789 A1
(43) Pub. Date: Mar. 3, 2011

(54) CRADLE HAVING GPS FUNCTION FOR PORTABLE DEVICE

(75) Inventor: Seongho Yoon, Seoul (KR)

(73) Assignee: NAMSUNG CO., LTD., Seoul (KR)

(21) Appl. No.: 12/652,198

(22) Filed: Jan. 5, 2010

(30) Foreign Application Priority Data
Sep. 3, 2009 (KR) 10-2009-0083141

(51) Int. Cl. G01C 21/36

(52) U.S. Cl. 701/213

(57) ABSTRACT

A cradle having a GPS function for a portable device includes: a housing that has a built-in GPS antenna, a built-in circuit board that converts a GPS signal received through the GPS antenna into traveling information of a vehicle and then transmits the traveling information to the portable device, and receives navigation information from the portable device, and one or more built-in speakers that vocally outputs the navigation information received through the circuit board, in which a direction change informing portion that is formed at both side ends of the front of a protruding portion that protrudes toward the driver's seat at the lower end of the housing, and informs a direction change of the vehicle on the basis of the navigation information.

### RELATED APPLICATIONS

The present application claims priority to Korean Patent Application Serial Number 10-2009-0083141, filed on Sep. 3, 2009, the entirety which is hereby incorporated by reference.

### BACKGROUND OF THE INVENTION

1. Field of the Invention

The present invention relates to a cradle having a GPS function for a portable device, in detail, a cradle having a GPS function for a portable device which is connected with a portable device, which can output an image and a voice, and guides a course.

2. Description of the Related Art

Recently, portable devices, such as an iPod providing an expanded function by installing lots of software as well as the basic functions, such as playing music and video, and photograph and text viewers, have increasingly come into wide use.

Most portable devices are manufactured in a small size to improve portability. Portable devices have built-in memory and battery to reduce the size. Portable devices, including the iPod, have a built-in large-capacity memory. However, most users use portable devices only to play sound source files (e.g. mp3, ogg, wma, flac etc.) or video files (e.g. mp4, avi, mpg etc.). Accordingly, there is a problem in that portable devices are used only to May sound source files or video files, but the large-capacity memory is not effectively used.

In the US, even though there are iPod products, many consumers are not satisfied with using them in a vehicle, and even though there are portable devices having a large-capacity memory, they have an inconvenience of having to separately purchase an expensive navigation device.

Further, since the portable devices use a built-in battery, a separate charger for charging the battery is required. In particular, a cradle is mounted on the dash board of vehicles to charge the battery of portable devices in the vehicles. Cradles provided in vehicles are used only to charge the battery of a portable device held therein. In this configuration, the cradles receive power from the battery of vehicles, and for consumers, it deteriorates efficiency to place a large charging device on the dash board only for charging.

Therefore, it is required to improve usability of portable devices by utilizing the space for the large-capacity memory of portable devices and to efficiently use the portable devices by providing a cradle in vehicles with additional functions, other than using the cradle in vehicles to charge a battery.

### SUMMARY OF THE INVENTION

In order to overcome the problems in the related art, it is an object of the present invention to provide a cradle having a GPS function for a portable device in which a GPS function is additionally provided to the cradle mounted in a vehicle to charge a portable device and large-sized map data is stored in the portable device.

The cradle having a GPS function for a portable device according to an embodiment of the present invention to accomplish the object, includes: a housing that has a built-in GPS antenna, a built-in circuit board that converts a GPS signal received through the GPS antenna into traveling information of a vehicle and then transmits the traveling information to the portable device, and receives navigation information from the portable device, and one or more built-in speaker that vocally outputs the navigation information received through the circuit board, in which a direction change informing portion, which is formed at both side ends of the front of a protruding portion that protrudes toward the driver's seat at the lower end of the housing, and informs a direction change of the vehicle on the basis of the navigation information, is disposed.

A connecting portion that is detachably connected with a fixing member attached to the vehicle is formed the rear of the housing, and a built-in battery that supplies power to the circuit board when the connecting portion is not connected with the fixing member is additionally disposed in the housing.

The protruding portion has a receiving portion, which receives remote control information, at the front.

The direction change informing portion includes a first LED module corresponding to a left turn of the vehicle and a second LED module corresponding to a right turn of the vehicle.

The circuit board includes: a GPS process module that converts a GPS signal received from the GPS antenna into traveling information; a control module that performs a control to communicate traveling information and navigation information with the portable device, performs a control to vocally output the navigation information, and performs a control to turn on or off the direction change informing portion on the basis of the navigation information; an interface module that transmit the traveling information converted by the GPS process module to the portable device through a connector in response to control of the control module, and receives the navigation information from the portable device through the connector; a voice output unit that vocally outputs the navigation information through the one or more built-in speakers of the housing in response to control of the control module; and a direction change informing portion-activating module that turns on or off the direction change informing portion in response to control of the control module.

Further, a cradle having a GPS function for an iPod touch according to an embodiment of the present invention to accomplish the object, includes: a housing that has a built-in GPS antenna, a built-in circuit board that converts a GPS signal received through the GPS antenna into traveling information of a vehicle and then transmits the traveling information to the iPod touch, and receives navigation information from the iPod touch and one or more built-in speakers that vocally outputs the navigation information received through the circuit board, in which a direction change informing portion that is formed at both side ends of the front of a protruding portion that protrudes toward the driver's seat at the lower end of the housing, and informs a direction change of the vehicle on the basis of the navigation information.

A connecting portion that is detachably connected with a fixing member attached to the vehicle is formed at the rear of the housing, and a built-in battery that supplies power to the circuit board when the connecting portion is not connected with the fixing member is additionally disposed in the housing.

The protruding portion has a receiving portion, which receives remote control information, at the front.

The direction change informing portion includes a first LED module corresponding to left turn of the vehicle and a second LED module corresponding to the right turn of the vehicle.

The circuit board includes: a GPS process module that converts a GPS signal received from the GPS antenna into traveling information; a control module that performs a control to communicate traveling information and navigation information with the iPod touch, performs a control to vocally output the navigation information, and performs a control to turn on or off the direction change informing portion on the basis of the navigation information; an interface module that transmits the traveling information converted by the GPS process module to the portable device through a connector in response to control of the control module, and receives the navigation information from the iPod touch through the connector; a voice output unit that vocally outputs the navigation information through the one or more built-in speakers of the housing in response to control of the control module; and a direction change informing portion-activating module that turns on or off the direction change informing portion in response to control of the control module.

According to the present invention, by installing a navigation program in the portable device and holding and using the portable device in the cradle having a GPS function, a user having the portable device can use the navigation function at the minimum cost, without needing to separately purchase a navigation device.

Further, with the use of the cradle having a GPS function, it is not necessary to additionally install a navigation device in a vehicle, such that it is possible to maximally utilize the space in the vehicle while providing convenience for a driver, and also, it is possible to maximize usability of the portable device and efficiently use the narrow space in the vehicle.

Further, since a lot of consumers have iPod touch in the US and they can purchase the cradle provided with a GPS function at a low cost without separately purchasing a navigation device and the cradle for charging, if at least only 1% of the consumers having an iPod purchase this product, the manufactures can make a lot of sales profit.

### BRIEF DESCRIPTION OF THE DRAWINGS

FIGS. 1 and 4 are views illustrating a cradle having a GPS function for a portable device according to an embodiment of the present invention;

FIG. 5 is a view illustrating a protruding portion of a housing of the cradle having a GPS function for a portable device according to an embodiment of the present invention;

FIGS. 6 and 7 are views illustrating the sides of the housing of the cradle having a GPS function for a portable device according to an embodiment of the present invention;

FIGS. 8 and 9 are views illustrating the rear of the housing of the cradle having a GPS function for a portable device according to an embodiment of the present invention; and

FIG. 10 is a block diagram illustrating a circuit board that is disposed in the housing of the cradle having a GPS function for a portable device according to an embodiment of the present invention; and

FIG. 11 is a block diagram illustrating a portable device according to an embodiment of the present invention.

### DETAILED DESCRIPTION OF THE PREFERRED EMBODIMENTS

The most preferred embodiment of the invention is described hereafter in detail with reference to the accompanying drawings to describe in detail it such that those skilled in the art can easily implement the technical spirit of the present invention. Giving reference numerals to components in each figure, it should be understood first that the same components are referred by the same reference numerals even if they are shown in different figures. Describing the invention herein, when it is considered that the detailed description about related known configurations or functions makes the aspects of the invention unclear, the detailed description may be omitted.

Prior to describing an embodiment of the present invention, the terms used herein to describe the embodiment of the present invention is defined as follows.

Traveling information implies RMC (Recommended Minimum Specific DNSS Data) including data items that are generally used in a navigation device, in various data received from a satellite. The RMC includes fields, such as Sentence ID, UTC Time, Latitude, N/S Indicator/Longitude, E/W Indicator, Speed over ground, UTC Data, and Magnetic variation. The Sentence ID implies the type of data and is expressed by $GPGGA, $GPGSV, $GPRMC, $GPVTG etc. The RMC is expressed by $GPRMC. The UTC Time implies Greenwich Mean Time, which is composed of date, time, minute, and second. The Latitude implies the latitude corresponding to the present location of GPS module. The N/S Indicator implies the north latitude and the south latitude. The Longitude implies the longitude corresponding to the present location of a GPS module. The E/W Indicator implies the east longitude and the west longitude. The Speed over ground implies the movement velocity of a GPS module. The traveling information includes various data received from a satellite, other than the above data.

Navigation information is information created from the traveling information received from a satellite. That is, the navigation information detects data of fields corresponding to vehicle velocity and present location, in the fields of the traveling information. The navigation information is information including a destination, estimated time of arrival to the destination, and movement course guide information. The destination and estimated time of arrival to the destination are created on the basis of destination information and traveling information that are inputted by a user.

A cradle having a GPS function for a portable device according to the present invention is described hereafter.

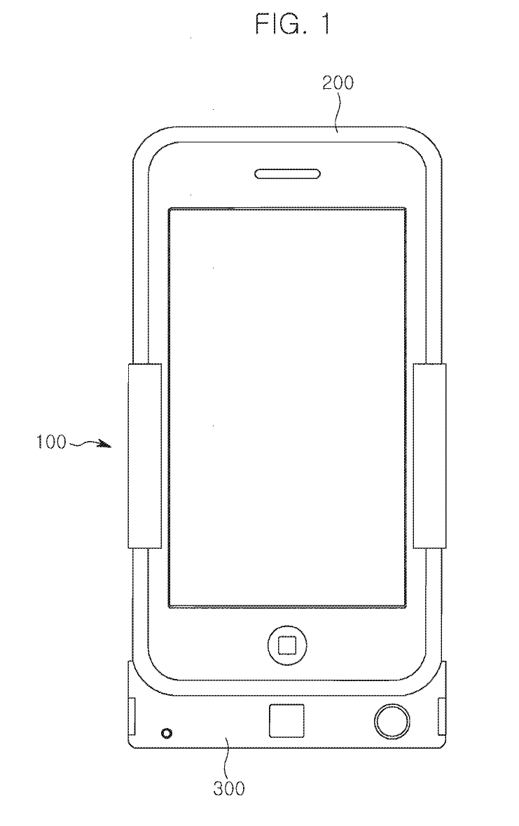

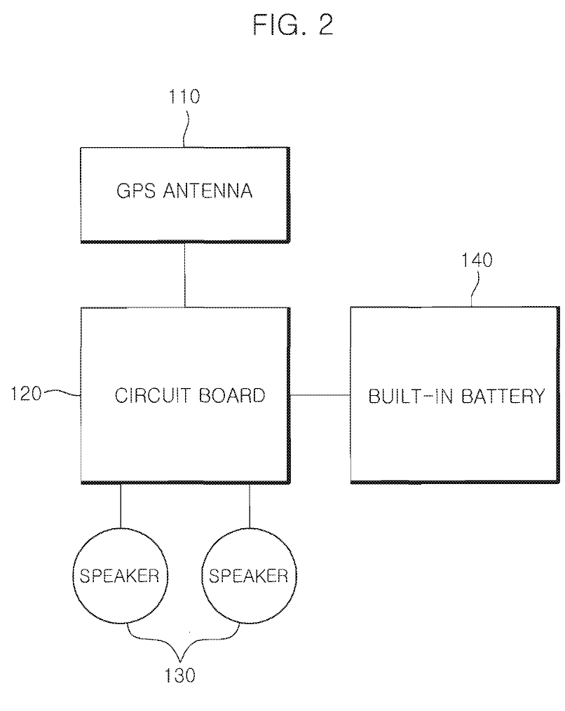

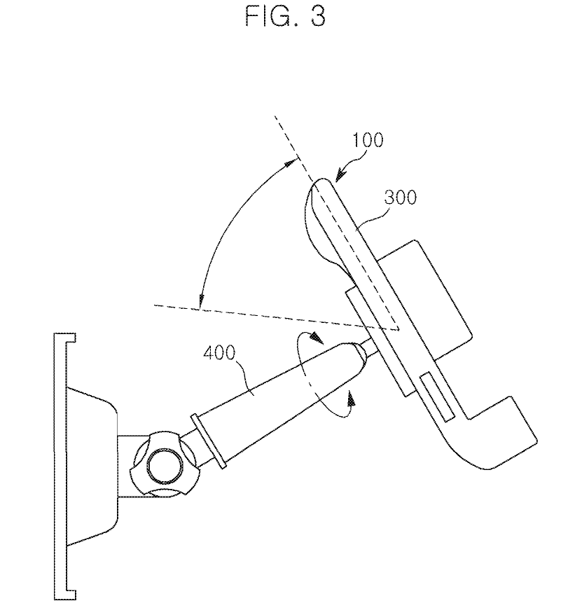

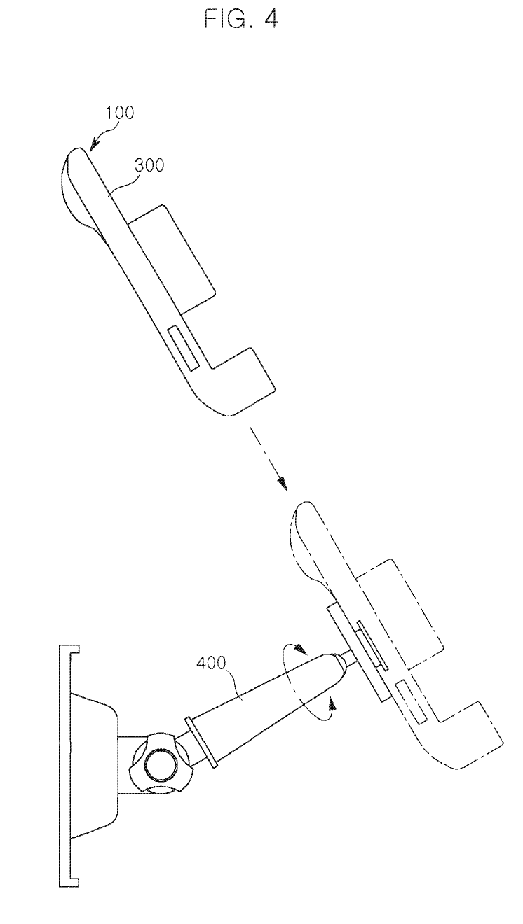

FIGS. 1 and 4 are views illustrating a cradle having a GPS function for a portable device according to an embodiment of the present invention.

A cradle 100 having a GPS function for a portable device is connected with a portable device 200 (e.g. an iPod touch) having a navigation program. The cradle 100 for a portable device includes a housing 300, and a GPS antenna 110, a circuit board 120, and one or more speakers 130 which are disposed in the housing 300. In this embodiment, the GPS antenna 110 communicates GPS signals with a plurality of satellites. The circuit board 120 converts GPS signals received through the GPS antenna 110 into traveling information of a vehicle and transmits it to the portable device 200, and receives navigation information from the portable device 200. The one or more speakers 130 vocally outputs navigation information received through the circuit board 120.

As shown in FIG. 4, the cradle 100 for a portable device can be separated from a fixing member 400 fixed to a dash board (not shown). That is, the cradle 100 for a portable device is separated from the fixing member 400 and can operate as a navigation device. In this case, a built-in battery 140 supplying power to the circuit board 120 is additionally provided in the cradle 100 for a portable device. Further, the built-in battery 140 may supply power to the portable device 200 connected to the cradle 100 for a portable device.

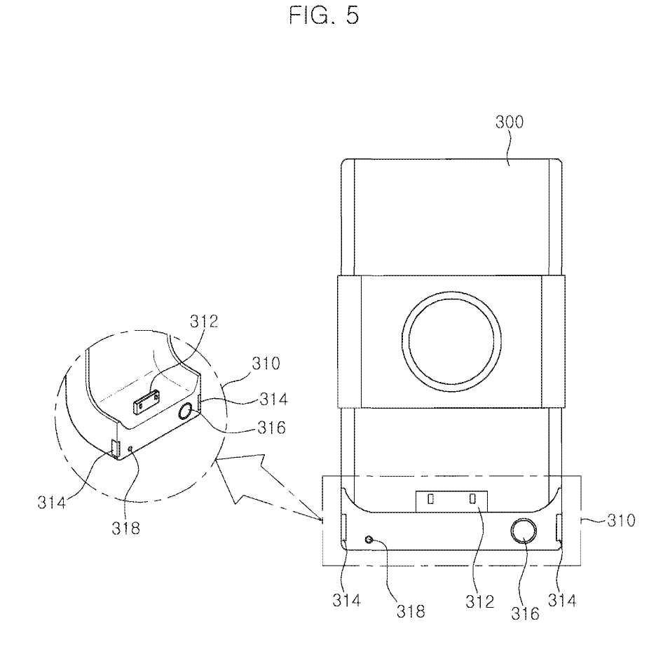

FIG. 5 is a view illustrating a protruding portion of a housing of the cradle having a GPS function for a portable device according to an embodiment of the present invention.

As shown in FIG. 5, the housing 300 of the cradle 100 having a GPS function for a portable device has a protruding portion 310, which protrudes toward the driver's seat, at the lower portion of the front. A connector 312, a direction change informing portion 314, a receiving portion 316, and power display 318 are formed at the protruding portion 310.

The connector 312 protrudes on the upper surface of the protruding portion 310 and is fitted in a connector connecting portion (not shown) formed at one side of the portable device 200 (e.g. iPod touch). The connector 312 communicates data, such as traveling information and navigation information, with the portable device 200 (e.g. iPod touch). Further, the connector 312 functions as a power supply line through which power is supplied to charge the portable device 200, which is the basic function of the cradle 100.

The direction change informing portion 314 is formed at both side ends of the front of the protruding portion 310 and informs a direction change of a vehicle on the basis of the navigation information received from the portable device 200. In this configuration, the direction change informing portion 314 includes a first LED module 314a formed at the left side of the front of the protruding portion 310 and a second LED module 314b formed at the right side of the front of the protruding portion 310.

That is, when receiving navigation information corresponding to a left turn, the direction change informing portion 314 turns on or off the first LED module 314a to inform the driver of the left turn of the vehicle. When receiving navigation information corresponding to a right turn, the direction change informing portion 314 turns on or off the second LED module 314b to inform the driver of the right turn of the vehicle.

The receiving portion 316 is formed on the front of the protruding portion 310 and receives remote control information. That is, the receiving portion 316 receives control information (that is, information for controlling the cradle 100; e.g. turning-on/off of the cradle 100, volume-up/down of the speaker 130 etc.) which is generated when a user operates a remote controller.

The power display 318 is formed on the front of the protruding portion 310 and displays power-on/off of the cradle 100. In this configuration, the power display 318 displays power-on of the cradle 100 by generating green light and power-off of the cradle 100 by generating red light. Alternatively, it is possible for those skilled in the art to display power-on/off of the cradle 100 in various ways, other than the method described above.

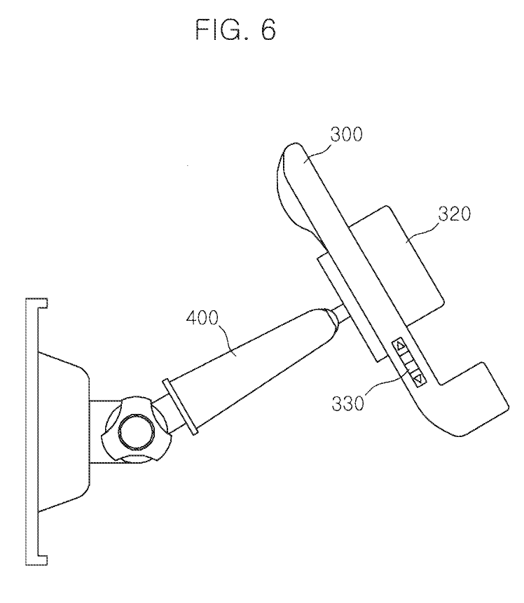

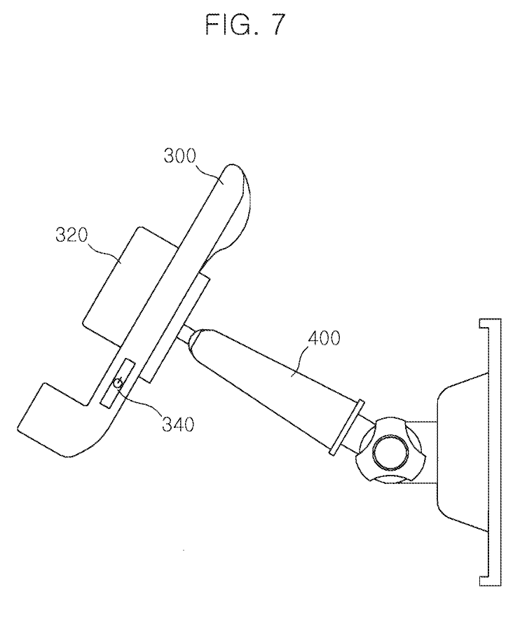

FIGS. 6 and 7 are views illustrating the sides of the housing of the cradle having a GPS function for a portable device according to an embodiment of the present invention.

The housing 300 of the cradle 100 having a GPS function for a portable device has fixing portions 320, a volume control portion 330, and power button 340 at the sides.

The fixing portions 320 are formed at both sides of the housing 300 and fix the portable device 200. The fixing portions 320 fix the portable device 200 not to move, by applying a force to both sides of the portable device 200. The fixing portions 320 are formed in various shapes in accordance with the shape of the portable device 200 that is placed on the cradle 100. Since the fixing portions 320 can be formed in various shapes for fixing the portable device 200 by those skilled in the at, the detailed description is not provided.

The volume control portion 330 is formed of a button or a wheel for controlling the volume of the built-in speakers 130 of the housing 300, at one side of the housing 300. Although the volume control portion 330 is formed at one side of the housing 300 in this embodiment, it may be formed at the upper portion, lower portion, rear, and front of the housing 300.

The power button 340, which is a button for turning on/off the power of the cradle 100, is formed at one side of the housing 300. The power button 340 is formed at the same side as the volume control portion 330 or the opposite side to the volume control portion 330. Although the power button 340 is formed at one side of the housing 300, it may be formed at the upper portion, lower portion, rear, and front of the housing 300.

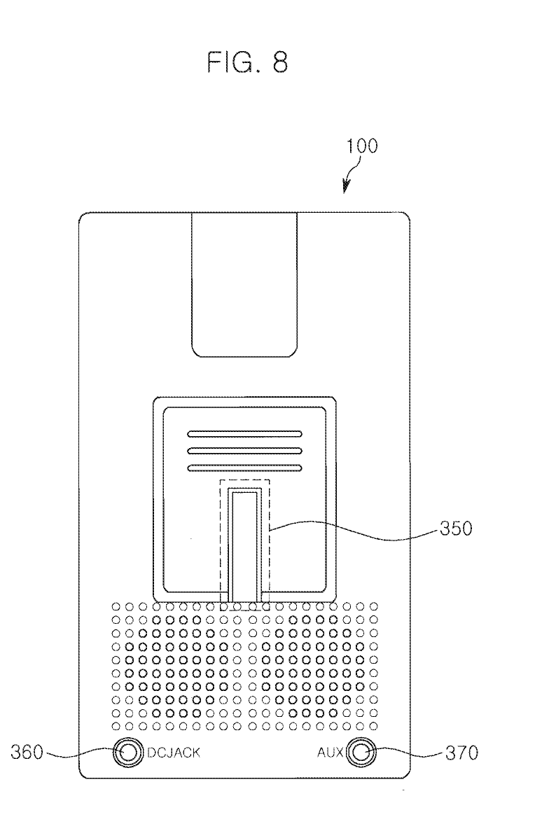

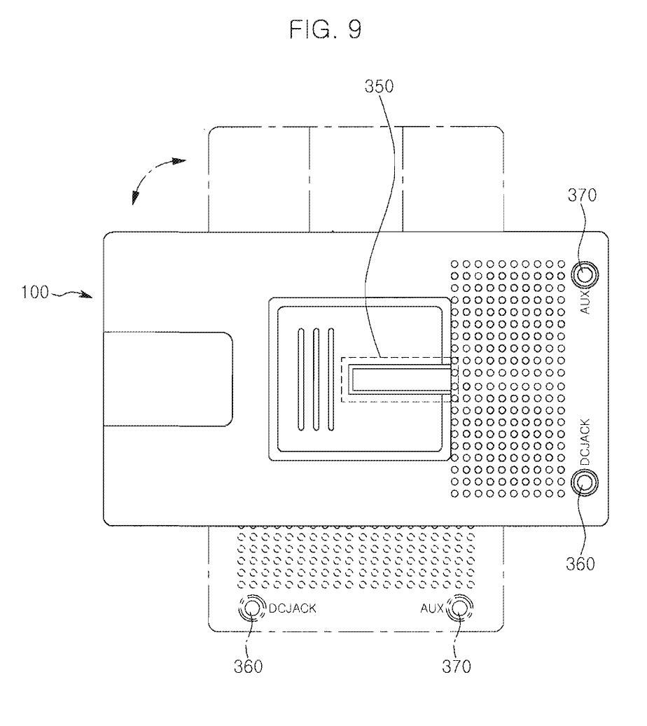

FIGS. 8 and 9 are views illustrating the rear of the housing of the cradle having a GPS function for a portable device according to an embodiment of the present invention.

As shown in FIG. 8, the housing 300 of the cradle 100 having a GPS function for a portable device has a connecting portion 350, a power supply terminal 360, and an auxiliary input terminal (AUX) 370 at the rear.

The connecting portion 350 is formed on the rear of the housing 300 and connected with the fixing member 400 attached to a dash board (not shown). In this configuration, the connecting portion 350 is detachably connected with the fixing member 400 to utilize the cradle 100 as a portable navigation device. The connecting portion 350 is connected to rotate about the portion connected with the fixing member 400. That is, as shown in FIG. 9, the connecting portion 350 is connected to rotate about the portion connected with the fixing member 400 to ensure the viewing angle of the portable device 200 held in the cradle 100 or rotate the display.

The power supply terminal 360 is connected with a cigar jack (not shown) of a vehicle through a power cable and supplies power supplied from the vehicle to the built-in circuit board 120 of the cradle 100.

The auxiliary input terminal 370 transmits voice output of the portable device 200 to the car audio (not shown), for voice output through the car audio (not shown). In this embodiment, the auxiliary input terminal 370 is formed in various types, such as a 3.5 stereo terminal and a gender, and is connected with the car audio (not shown) through a corresponding cable.

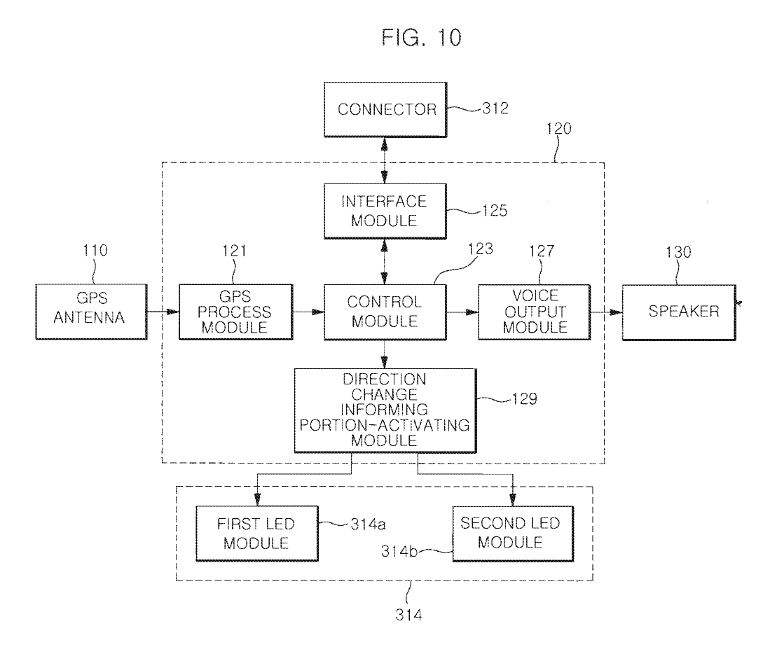

FIG. 10 is a block diagram illustrating a circuit board that is disposed in the housing of the cradle having a GPS function for a portable device according to an embodiment of the present invention.

As shown in FIG. 10, the built-in circuit board 120 of the housing 300 of the cradle 100 for a portable device includes a GPS process module 121, a control module 123, an interface module 125, a voice output module 127, and a direction change informing portion-activating module 129.

The GPS module 121 detects data (e.g. RMC) which is used in a navigation device, in the data received from a satellite through a GPS antenna 110. For example, the GPS process module 121 detects data in which the Sentence ID is “$GPRMC” from received data, in order to detect RMC, which is used for navigation, in the data received from a satellite through the GPS antenna 110.

The GPS process module 121 creates traveling information, using the detected data. That is, the GPS module 121 create traveling data by detecting data corresponding to date, location (i.e., latitude, longitude, north latitude, south latitude, east longitude, and west longitude), and movement velocity from the detected data. That is, the GPS process module 121 creates traveling information, from the detected RMC, in which UTC Date and UTC Time means date, Latitude means latitude, Longitude means longitude, N/S Indicator means north latitude and south latitude, E/W indicator means east longitude and west longitude, and Speed over ground means movement velocity. The movement velocity included in the RMC has a unit of Knots for the sea. For example, when the detected RMC is “$GPRMC, 141113, 999, A, 3730.0308, N, 12655.2369, E, 19.77, 195.23, 101200, *3C”, the GPS process module 121 creates traveling information in which the date is Dec. 10, 2000 14:11:13, the location is 3730.0308 north latitude and 12655.2369 east longitude, and the movement velocity is 19.77.

The control module 123 performs a control to communicate traveling information and navigation information with the portable device 200. That is, the control module 123 controls the interface module 125 transmit the traveling information created by the GPS process module 121 to the portable device 200 held in the cradle 100 and receive navigation information from the portable device 200.

The control module 123 performs a control to vocally output navigation information. That is, the control module 123 controls the voice output module 127 to vocally output voice information that informs a movement course of navigation information and navigation information including movement velocity information.

The control module 123 performs a control to turn on or off the direction change informing portion 314 on the basis of the navigation information. That is, the control module 123 controls the direction change informing portion-activating module 129 to turn on or off the corresponding direction change informing portion 314, when it is required to change direction (e.g. left turn, right turn) in accordance with the movement course of the navigation information.

The interface module 125 is connected with the connector 312 formed on the protruding portion 310 and communicates traveling information and navigation information with the portable device 200 in response to control of the control module 123. That is, the interface module 125, in response to control of the control module 12e, transmits traveling information converted by the GPS process module 121 to the portable device 200 through the connector 312 and receives navigation information from the portable device 200 through the connector 312. In this process, the interface module 125 transmits traveling information including date, location, movement velocity etc. to the portable device 200 in response to control of the control module 123 and transmits navigation information including a destination, estimated time of arrival to the destination, movement course guide information, and estimated time of arrival to the portable device 200.

The voice output module 127 vocally outputs the traveling information and navigation information from the interface module 125 through one or more built-in speakers 130 of the housing 300. That is, the voice output module 127 vocally informs a driver of movement velocity, location, date, destination, estimated time of arrival to destination, movement course guide information, and estimated time of arrival etc. through the speakers 130.

The direction change informing portion-activating module 129 turns on or off the direction change informing portion 314 in response to control of a control unit 240. That is, the direction change informing portion-activating module 129 informs a driver on left turn of the vehicle by turning on or off the first LED module 14a, when receiving navigation information corresponding to the left turn. The direction change informing portion-activating module 129 informs the driver of a right turn of the vehicle by turning on or off the second LED module 314b, when receiving navigation information corresponding to the right turn.

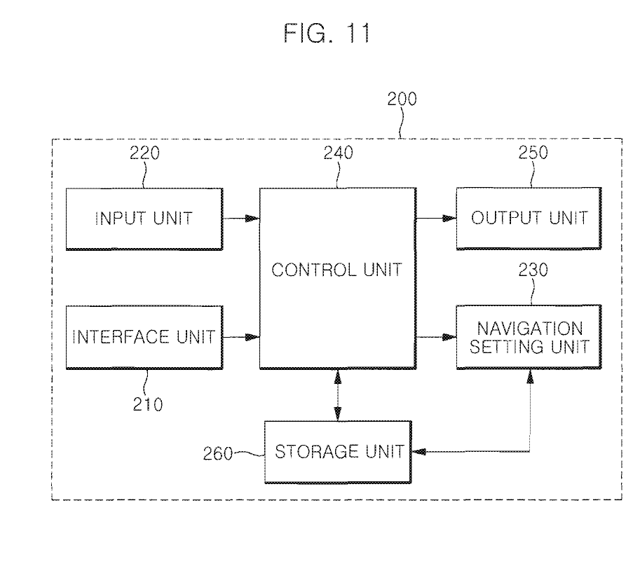

Hereinafter, a portable device that is connected to a cradle having a GPS function for a portable device according to an embodiment of the present invention. FIG. 11 is a block diagram illustrating a portable device according to an embodiment of the present invention.

As shown in FIG. 11, the portable device 200 that is connected to the cradle 100 having a GPS function for a portable device includes an interface unit 210, an input unit 220, a navigation setting unit 230, a control unit 240, an output unit 250, and a storage unit 260. The above components are implemented by software installed in a built-in memory of the portable device 200.

The interface unit 210 is connected with a connector connecting portion (not shown) that is fitted on the connector 312 formed on the protruding portion 310. The interface unit 210 communicates traveling information and navigation information with the interface module 125 of the cradle 100 in response to control of the control unit 240, That is, the interface unit 210 receives traveling information from the interface module 125 in response to control of the control unit 240 and transmits navigation information created by the navigation setting unit 230 to the interface module 125.

The input unit 220 receives destination information and control information that correspond to the arrival location of a vehicle. That is, the input unit 220 receives information (i.e. destination information and control information) for controlling common navigation functions, such as destination information, selection, guide start, search, and place name input. In this configuration, the input unit 200 is formed of an input device of the portable device 200 (e.g. key button, jog button, touch screen etc.). For example, for an iPod touch by Apple), destination information is inputted by a virtual keyboard displayed on the touch screen.

The navigation setting unit 230 creates navigation information of the vehicle on the basis of inputted destination information and traveling information from the cradle 100 for a portable device. That is, the navigation setting unit 230 creates navigation information including a destination, estimated time of arrival to destination, movement course guide information etc. In this process, the navigation setting unit 230 sets destination on the basis of the destination information inputted to the input unit 220. The navigation setting unit 230 creates the movement course, using the present location information and destination information of the traveling information. The navigation setting unit 230 creates the estimated time of arrival on the basis of the inputted destination information, movement velocity, and movement course. In this process, the navigation setting unit 230 converts the movement velocity included in the traveling information into km/h. That is, since the movement velocity included in the traveling information has a unit of Knots for the sea, the navigation setting unit 230 converts the movement velocity included in the traveling information into km/h, using the following Formula 1. For example, when the movement velocity included in the traveling information is 19.77 Knots, the navigation setting unit 230 converts the velocity into 36.614 km/h, using Formula 1.

Movement velocity (km/h)=Speed over ground (Knots)×1.852 [Formula 1]

where, it can be easily understood by those skilled in the art that the navigation setting unit 230 creates the movement course, destination, and estimated time of arrival to destination etc., and thus the detailed description is not provided.

The control unit 240 performs a control to output navigation information and map information set by the navigation setting unit 230. That is, the control unit 240 performs a control to output navigation information, which includes vehicle velocity, the present location, destination, estimated time of arrival, movement course etc., and map information. The map information is information including buildings, roads, and speed limit, etc. in the surround area of the navigation information. The present location changes with movement of the vehicle. Therefore, the control unit 240 detects map information corresponding to the present location from the storage unit 260 every time the present invention changes, and controls the output unit 250 to output it.

The output unit 250 displays or vocally outputs navigation information and map information of a vehicle in response to control of the control unit 240. That is, the output unit 250 displays map information and navigation information, such as a common navigation, using a display device, such as LCD and AMOLED etc. of the portable device 200.

The output unit 250 may vocally output navigation information through the built-in speakers 130 of the cradle 100 having a GPS function for a portable device or a car audio. That is, the output unit 250 may vocally output corresponding navigation information and map information by transmitting navigation information and map information to the built-in circuit board 120 of the cradle 100 through the interface unit 210. It may be possible that the cradle 100 transmits navigation information and map information to the car audio through the auxiliary input terminal 370 formed on the rear and then the navigation information and the map information is vocally outputted from the car audio.

The storage unit 260 stores map information that is used for navigation. That is, the storage unit 260 stores map information including buildings around, roads around, speed limit etc. The storage unit 260 corresponds to the built-in memory of the portable device 200.

As described above, by installing a navigation program in the portable device 200 and holding and using the portable device 200 in the cradle 100 having a GPS function, a user having the portable device 200 can use a navigation function at the minimum cost, without needing to separately purchase a navigation device.

Further, with the use of the cradle 100 having a GPS function, it is not necessary to additionally install a navigation device in a vehicle, such that it is possible to maximally utilize the space in the vehicle while providing convenience to a driver, and also, it is possible to maximize usability of the portable device 200 and efficiently use the narrow space in the vehicle.

Further, since a lot of consumers have iPod touch in the US and they can purchase the cradle 100 provided with a GPS function at a low cost without separately purchasing a navigation device and the cradle 100 for charging, if at least only 1% of the consumers having iPod purchase this product, the manufactures can make a lot of sales profit.

Although the preferred embodiments of the invention have been disclosed, it should be understood that the present invention can be achieved by various changed and modified embodiments by those skilled in the art, without departing from the claims of the present invention.

What is claimed is:

1. A cradle having a GPS function for a portable device, comprising:
a housing that has a built-in GPS antenna, a built-in circuit board that converts a GPS signal received through the GPS antenna into traveling information of a vehicle and then transmits the traveling information to portable device, and receives navigation information from the portable device, and one or more built-in speakers that vocally outputs the navigation information received through the circuit board,
wherein a direction change informing portion, which is formed at both side ends of the front of a protruding portion that protrudes toward the driver's seat at the lower end of the housing, and informs a direction change of the vehicle on the basis of the navigation information, is disposed.

2. The cradle having a GPS function for a portable device according to claim 1, wherein a connecting portion that is detachably connected with a fixing member attached to the vehicle is formed at the rear of the housing, and
a built-in battery that supplies power to the circuit board when the connecting portion is not connected with the fixing member is additionally disposed in the housing.

3. The cradle having a GPS function for a portable device according to claim 1, wherein the protruding portion has a receiving portion, which receives remote control information, at the front.

4. The cradle having a GPS function for a portable device according to claim 1, wherein the direction change informing portion includes a first LED module corresponding to a left turn of the vehicle and a second LED module corresponding to a right turn of the vehicle.

5. The cradle having a GPS function for a portable device according to claim 1, wherein the circuit board includes:
a GPS process module that converts a GPS signal received from the GPS antenna into traveling information;
a control module that performs a control to communicate traveling information and navigation information with the portable device, performs a control to vocally output the navigation information, and performs a control to turn on or off the direction change informing portion on the basis of the navigation information;
an interface module that transmits the traveling information converted by the GPS process module to the portable device through a connector in response to control of the control module, and receives the navigation information from the portable device through the connector;
a voice output unit that vocally outputs the navigation information through the one or more built-in speakers of the housing in response to control of the control module; and
a direction change informing portion-activating module that turns on or off the direction change informing portion in response to control of the control module.

6. A cradle having a GPS function for an iPod touch, comprising:
a housing that has a built-in GPS antenna, a built-in circuit board that converts a GPS signal received through the GPS antenna into traveling information of a vehicle and then transmits the traveling information to the iPod touch, and receives navigation information from the iPod touch and one or more built-in speakers that vocally outputs the navigation information received through the circuit board,
wherein a direction change informing portion that is formed at both side ends of the front of a protruding portion that protrudes toward the driver's seat at the lower end of the housing, and informs a direction change of the vehicle on the basis of the navigation information.

7. The cradle having a GPS function for an iPod touch according to claim 6, wherein a connecting portion that is detachably connected with a fixing member attached to the vehicle is formed at the rear of the housing, and
a built-in battery that supplies power to the circuit board when the connecting portion is not connected with the fixing member is additionally disposed in the housing.

8. The cradle having a GPS function for an iPod touch according to claim 6, wherein the protruding portion has a receiving portion, which receives remote control information, at the front.

9. The cradle having a GPS function for an iPod touch according to claim 6, wherein the direction change informing portion includes a first LED module corresponding to left turn of the vehicle and a second LED module corresponding to the right turn of the vehicle.

10. The cradle having a GPS function for an iPod touch according to claim 6, wherein the circuit board includes:
a GPS process module that converts a GPS signal received from the GPS antenna into traveling information;
a control module that performs a control to communicate traveling information and navigation information with the iPod touch, performs a control to vocally output the navigation information, and performs a control to turn on or off the direction change informing portion on the basis of the navigation information;
an interface module that transmits the traveling information converted by the GPS process module to the portable device through a connector in response to control of the control module, and receives the navigation information from the iPod touch through the connector;
a voice output unit that vocally outputs the navigation information through the one or more built-in speakers of the housing in response to control of the control module; and
a direction change informing portion-activating module that turns on or off the direction change informing portion in response to control of the control module.
